(19) United States
(12) Patent Application Publication
(10) Pub. No.: US 2009/0188336 A1
(43) Pub. Date: Jul. 30, 2009

(54) TRANSMISSION COMPRISING A DEVICE FOR DETECTING ROTATIONAL SPEED

(76) Inventor: Kim Fuhrer, Lindau (DE)

Correspondence Address: DAVIS & BUJOLD, P.L.L.C., 112 PLEASANT STREET, CONCORD, NH, 03301, US

(21) Appl. No.: 12/300,871

(22) PCT Filed: Apr. 25, 2007
(86) PCT No.: PCT/EP07/54018

§ 371 Date: Nov. 14, 2008

(30) Foreign Application Priority Data
May 19, 2006 (DE) 10-2006-023553.3

(51) Int. Cl. F16H 3/093; G01M 15/00

(52) U.S. Cl. 74/331; 73/114.25

(57) ABSTRACT

A transmission with a rotation speed determining device includes a rotation speed indicator (21) connected in a rotationally fixed manner to a transmission shaft (3) and a stationary rotation speed sensor (22) such that the rotation speed of the transmission shaft can be determined from the rotation speed indicator. The rotation speed indicator extends radially outward into at least one guide (33, 35) which reduces the axial play of the rotation speed indicator. With this transmission, the rotation speed of the transmission shaft can be determined particularly reliably.

This application is a national stage completion of PCT/EP2007/054018 filed Apr. 25, 2007, which claims priority from German Application Serial No. 10 2006 023 553.3 filed May 19, 2006.

### FIELD OF THE INVENTION

The present invention concerns a transmission, in particular for a motor vehicle, with a device for determining rotation speed which comprises a rotation speed indicator connected in a rotationally fixed manner to a transmission shaft and a stationary rotation speed sensor, such that the speed of the transmission shaft can be determined from the rotation speed indicator.

### BACKGROUND OF THE INVENTION

From the prior art, transmissions are known which comprise rotation speed determining devices in order to generate a speed signal for a motor vehicle or the like. These rotation speed determining devices essentially comprise a signal or rotation speed indicator in a rotationally fixed manner with the corresponding transmission shaft, associated with a stationary rotation speed sensor to determine the speed from the rotation speed indicator.

DE 198 14 758 A1, in general, describes a device for determining the rotation speed of a shaft. The known device has a signal transmitter fixed in a rotationally fixed manner to the shaft, which is formed in a toothed wheel whose teeth each have a steep and a flatter tooth flank. In addition, an analog Hall-effect sensor is provided, which measures the rotation speed in the radial direction at the circumference of the toothed wheel, i.e., at the teeth. Thanks to the different flank slopes of the two tooth flanks, the rotation speed and direction of the shaft can be determined with only one sensor and with a constant update rate, even when the shaft is rotating at a very low speed.

DE 103 42 494 A1 describes a similar arrangement, intended to determine the torque on transmission shafts. For that purpose, the known device comprises a transmission shaft on which a rotation speed indicating gear wheel is arranged in a rotationally fixed manner. This rotation speed indicates gear wheel again being associated with a stationary speed sensor which determines the rotation speed in the radial direction at the circumference of the rotation speed indicating gear wheel, i.e., at the teeth thereof. This means that when the teeth of the rotation speed indicating gear wheel rotate past the speed sensor, they generate electric pulses which are sent to a corresponding evaluation unit.

Another rotation speed determining device for a transmission of a motor vehicle is disclosed in DE 102 23 625 A1. In this rotation speed determining device, which also comprises a signal transmitter and a sensor, the signal transmitter is integrated in a dust protection cover for a shaft sealing ring on the drive output side. The dust protection cover is arranged outside the transmission housing and is connected in a rotationally fixed manner to the drive output side of the transmission, whereas the sensor is fixed on the outside of the housing and determines the rotation speed in the radial direction at the circumference of the dust protection cover.

Whereas with the rotation speed determining devices, mentioned above, the speed is measured in the radial direction, other rotation speed determining devices are known from practice with which the speed sensor measures the rotation speed in the radial direction from the speed indicator, the signal transmitter or rotation speed indicator gear wheel.

The rotation speed determining devices, known from the prior art, have proved their worth, but are not an adequate solution in the case of transmission shafts with floating bearings and/or a large axial play. Thus in transmissions with a transmission shaft of that type, it is not necessarily guaranteed that the rotation speed can be determined reliably from the speed indicator.

Accordingly, the purpose of the present invention is to provide a transmission with a rotation speed determining device which ensures reliable determination of the rotation speed even in the case of transmission shafts with floating bearings or ones with a large axial play.

### SUMMARY OF THE INVENTION

A transmission, which can be used in a motor vehicle, comprises a rotation speed determining device. The rotation speed determining device comprises a rotation speed indicator connected in a rotationally fixed manner to a transmission shaft and a stationary speed sensor, such that the rotation speed of the transmission shaft can be detected. The speed sensor can be a Hall effect sensor, an induction sensor or the like. The rotation speed indicator extends radially outward into at least one guide that reduces the axial play of the speed indicator. Such a guide can be provided on the transmission housing or on some other transmission component.

The invention has the advantage that the axial play of the rotation speed indicator is restricted by the guide so that the speed indicator itself, if the axial play of the transmission shaft is particularly large, is held and guided within a range in which the fixed speed sensor can detect the rotation speed from the speed indicator.

In a preferred embodiment of the transmission, the guide cooperates with the rotation speed indicator in such a manner that the axial play of the latter can be reduced to a predetermined value. Thus, the predetermined value can be adapted to the properties of the rotation speed sensor by appropriate design of the guide.

In a particularly preferred embodiment of the transmission, the predetermined value is therefore smaller than a predetermined tolerance value of the speed sensor. This predetermined tolerance value can be understood to mean the maximum permissible axial play of the speed indicator at which detection is still possible by the rotation speed sensor. This embodiment always ensures reliable and secure determination of the rotation speed from the speed indicator.

In an advantageous embodiment of the transmission, the predetermined value is smaller than the axial play of the transmission shaft. In this way, the rotation speed determining device in particular can be used in transmissions whose transmission shaft is mounted in floating bearings or has a particularly large axial play.

To produce the above embodiment advantageously, as a further feature of the transmission, the rotation speed indicator is arranged so that it can move axially on the transmission shaft.

Transmission shafts with floating bearings can also undergo a wobble movement. To enable reliable determination in the transmission in this case too without damaging the guide or the rotation speed indicator, in a particularly preferred embodiment of the transmission, the rotation speed indicator is arranged on the transmission shaft in such a manner that the speed indicator can be inclined relative to the longitudinal axis of the transmission shaft. If the transmission shaft starts wobbling, no bending moment is transferred via the speed indicator to the guide, but rather the speed indicator tilts correspondingly relative to the transmission shaft in order to avoid such stress.

In a further preferred embodiment of the transmission, the transmission comprises at least one second transmission shaft and the guide is formed as an all-round groove in or on the second transmission shaft. In this way, an already existing transmission component is used, which moreover—when it is a countershaft—is arranged close to the first transmission shaft so that the speed indicator does not need to have a particularly large diameter in order to reach as far as the guide in the form of the all-round groove.

To ensure that the rotation speed indicator has a smaller axial play than the first transmission shaft, in an advantageous embodiment of the transmission, the second transmission shaft has a smaller axial play than the first transmission shaft.

To keep the manufacturing cost of the second transmission shaft down, in a particularly preferred embodiment of the transmission, the all-round groove has two groove flanks which are formed by the sides of two adjacent gear wheels on the second transmission shaft that face one another. Such a groove is in any case formed by two adjacent gear wheels a distance apart so no machining of the transmission shaft, such as turning an all-round groove in it, is necessary.

In a further embodiment of the transmission, the rotation speed sensor is orientated in such a manner that the speed can be determined in the axial direction from the rotation speed indicator. Since the ability to determine the rotation speed in such an embodiment depends in particular on the axial play of the speed indicator, the reduction of the axial play is especially advantageous with this embodiment.

To counteract wear on the rotation speed indicator and the guide or all-round groove, in a particularly preferred embodiment of the transmission the rotation speed indicator is made as a speed indicator disk with recesses on its side facing toward the rotation speed sensor. The recesses can be arranged in a circle one after another and are rotated past the speed sensor so that corresponding pulses are produced in the speed sensor. In contrast to the conventionally used rotation speed indicator gear wheels, in this embodiment the wear is less because the recesses are only provided on one side of the speed indicator disk while, in the case of the known speed indicator gearwheels, there are through-going tooth gaps between the teeth, which become worn by contact with the groove flanks on both sides. Moreover, in contrast to the through-going openings such as tooth gaps, recesses have the advantage that another transmission component rotating behind the recess cannot influence or falsify the measurement result.

To reduce the wear on the rotation speed indicator and the guide still further, in another preferred embodiment of the transmission, the recesses are a distance away from the edge of the rotation speed indicator disk. Consequently, a recess does not merge with the edge of the speed indicator, as is the case with an outward-extending tooth gap. In this way, the speed indicator disk can also be guided without friction on the side facing the speed sensor and, in addition, any clashing between the edge of the recesses and the teeth of the gearwheel on the second transmission shaft is largely excluded.

According to a further preferred embodiment of the transmission, the rotation speed indicator disk is made from a perforated disk and a covering disk joined surface-to-surface with one another. Thus the rims or walls of the recesses are defined by the perforated disk, whereas the covering disk forms the bottom of the recesses. The perforated and covering disks can for example be welded or brazed to one another. This embodiment has two substantial advantages. First, a particularly flat rotation speed indicator disk can be produced so that the overall length of the transmission is hardly increased at all. And the production cost is lower than for a speed indicator disk in which the recesses have to be formed in a single, thin disk blank.

In a further advantageous embodiment of the transmission, one of the groove flanks is formed exclusively by the teeth of a gear wheel and the side of the rotation speed indicator disk facing away from the speed sensor faces toward the groove flank. Since a groove flank, formed by the teeth of the gear wheel, can lead to increased wear on the rotation speed indicator disk, it is best for this groove flank to face toward the more wear-resistant, engaged side of the rotation speed indicator disk.

As a variation of the above embodiment, in a further advantageous embodiment of the transmission one of the groove flanks is formed at least partially by a engaged section of a gear wheel, the side of the rotation speed indicator disk that faces toward the rotation speed sensor facing toward the groove flank and the recesses in the speed indicator disk being arranged on the side opposite to the engaged section. Of course, the opposite arrangement concerns here only those recesses which are rotating in the all-round groove at the time.

The advantages achieved by the special design of the rotation speed determining device come particularly into their own in a further advantageous embodiment of the transmission in which the first transmission shaft is the main shaft and the second transmission shaft is a countershaft. The main shaft is mounted floating between two countershafts.

### BRIEF DESCRIPTION OF THE DRAWINGS

The invention will now be described, by way of example, with reference to the accompanying drawings in which:

FIG. 1 is a schematic representation of an embodiment of the transmission with a rotation speed determining device;

FIG. 2 is a plan view of the transmission of FIG. 1 in the area of the rotation speed determining device;

FIG. 3 is a side view of the transmission shown in FIGS. 1 and 2 in the area of the rotation speed determining device, and

FIG. 4 is a front view of the rotation speed indicator disk in FIGS. 1 to 3.

### DETAILED DESCRIPTION OF THE INVENTION

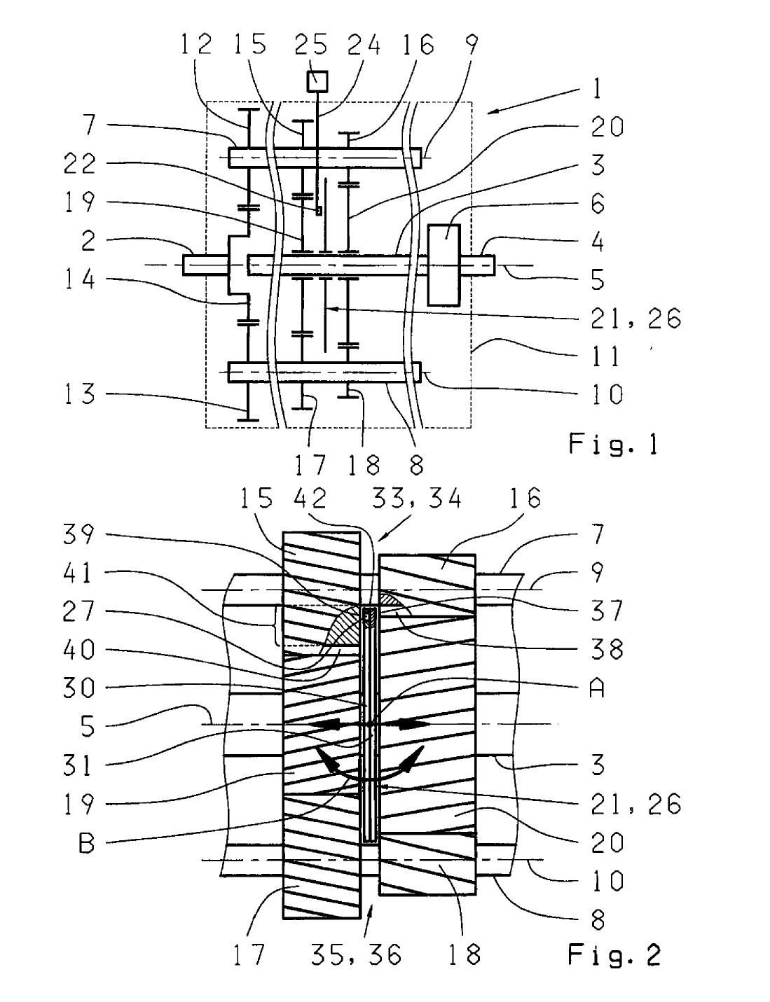

FIG. 1 shows a schematic representation of an embodiment of a transmission 1 for a motor vehicle. The transmission 1 is a co-axial transmission with a drive input shaft 2, a main shaft 3 and a drive output shaft 4, arranged one after another on an axis 5. The main shaft 3 is connected to the drive output shaft 4 by a planetary gear system 6 (here only indicated schematically). In addition two countershafts 7, 8 are provided, which extend parallel to the drive input shaft 2, the main shaft 3 and the drive output shaft 4 along two respective axes 9, 10. The main shaft 3 is mounted with large axial and radial play between the input shaft 2 and the output shaft 4. The transmission 1 also has a transmission housing 11 through which the ends of the input and output shafts 2, 4, facing away from the main shaft 3, extend outward.

On the countershafts are fixed respective drive gears 12, 13 each of which meshes with a drive output gear 14 of the drive input shaft 2 so that the countershafts 7, 8 can be driven by the drive input shaft 2. In addition, on the countershafts 7 and 8 are provided further fixed gear wheels 15, 16 and 17, 18 respectively, which mesh with loose gear wheels 19, 20 on the main shaft 3. The fixed gear wheels 15, 17 and the loose gear wheel 19 form the gearset for the second gear, while the fixed gear wheels 16, 18 and the loose gear wheel 20 form the gearset for the first gear. To create a rotationally fixed connection or coupling of the main shaft 3 to one of the loose gear wheels 19, 20, in addition, at least one shiftable clutch device is provided on the main shaft 3 (not shown for the sake of simplicity).

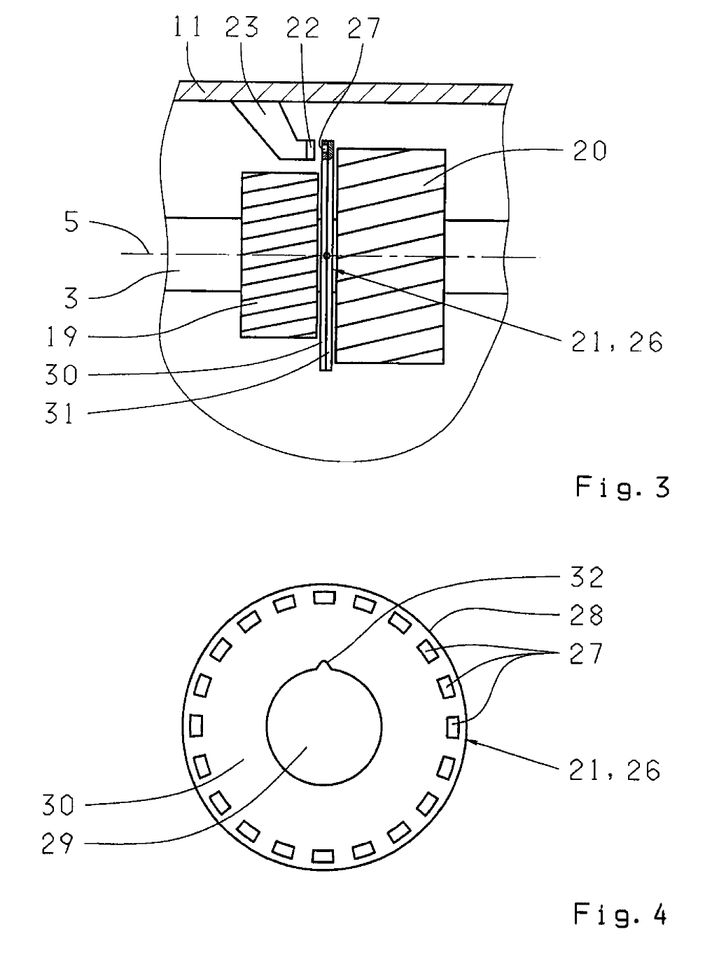

The transmission 1 also comprises a rotation speed determining device for determining the speed of the main shaft 3. The rotation speed determining device comprises essentially a rotation speed indicator 21 connected in a rotationally fixed manner to the main shaft 3 and positioned between the loose gear wheels 19, 20 and a fixed rotation speed sensor 22, attached via a holding arm 23 (FIG. 3) onto the transmission housing 11. With the help of the speed sensor 22, the rotation speed of the main shaft 3 can be detected from the speed indicator 20, the pulses generated in the speed sensor 22 being passed on via a lead 24 to an evaluation unit 25.

Below, the rotation speed determining device of the transmission I will be described in more detail with reference to FIGS. 2 to 4. In the embodiment illustrated, the rotation speed indicator 21 is made as a speed indicator disk 26. On its side facing toward the rotation speed sensor 22, the speed indicator disk 26 has recesses 27. These recesses 27 are arranged in a circle a distance apart from one another on the side of the speed indicator disk 26, as can be seen particularly clearly in FIG. 4 which shows a front view of the speed indicator disk 26. The recesses 27 are arranged a predetermined distance away from an edge 28 of the speed indicator disk 26, i.e., they do not merge into the edge 28 as is the case with speed indicator gear wheels. Also, the recesses 27 are not through-going openings in the speed indicator disk 26. However, the speed indicator disk 26 does have a central opening 29 enabling it to be fitted in a rotationally fixed manner onto the main shaft 3. The side of the rotation speed indicator disk 26 in which the recesses 27 are provided faces toward the rotation speed sensor 22, which is orientated (FIG. 3) so that the rotation speed of the main shaft 3 can be determined in an axial direction from the rotation speed indicator disk 26.

The rotation speed indicator disk 26 is made from a perforated disk 30 and a covering disk 31 joined surface-to-surface with one another, as can be seen in FIGS. 2 and 3. Thus, in a speed indicator disk of this type, the sides of the recesses are formed by the edges of the holes in the perforated disk 30 and the bottom of the recesses by the covering disk 31. This enables particularly thin speed indicator disks to be made and provided inexpensively, where a smaller overall transmission length can be achieved.

The rotation speed indicator disk 26 is arranged on the main shaft 3 so that it can move axially, as indicated by a double arrow A. Moreover, the speed indicator disk 26 is connected to the main shaft 3 in such a manner that it can be tilted relative to the longitudinal axis 5 of the main shaft 3 (double arrow B). Such a connection with the degrees of freedom can be achieved by making the diameter of the opening 29 in the speed indicator disk 26 larger than the diameter of the main shaft 3, which enables the tilting, while a securing spring (not shown) that extends on one side into the main shaft 3 and, on the other side, into a lateral recess 32 in the opening 29 of the speed transmission disk 26, produces a rotationally fixed connection.

The fixed gear wheels 15 and 16 are attached on the countershaft 7 an axial distance apart so that between them a guide 33 in the form of an all-round groove 34 is formed. The same applies to the fixed gear wheels 17, 18 on the countershaft 8, between which another guide 35 in the form of an all-round groove 36 is formed. What is said below concerning the guide 33 also applies correspondingly to the guide 35.

The all-round groove 34 has a first groove flank 37, which is formed by the side of the fixed gear wheel 16. The fixed gear wheel 16 has a diameter small enough for the first groove flank 37 to be formed exclusively by the sides of the teeth 38 of the fixed gear wheel 16. The all-round groove 34 also has a second groove flank 39 opposite the first groove flank 37, which is formed by the side of the fixed gear wheel 15. This second groove flank 39 is formed both by the sides of teeth 40 and by an engaged section 41 of the fixed gear wheel 15 near the axis. A base 42 of the all-round groove 34 is formed by the outer surface of the countershaft 7.

The rotation speed indicator disk 26 extends from the main shaft 3 radially outward and at its edge fits into the two all-round grooves 34, 36 so that the axial play of the speed indicator disk 27 is restricted or reduced by the two groove flanks 37, 38. The axial play of the speed indicator disk 26, relative to a fixed part of the transmission such as the rotary speed sensor 22, is thus reduced to a predetermined value determined by the axial play between the groove flanks 37, 38 and the axial play of the countershafts 7 and 8. The countershafts 7, 8 are mounted with little axial play and have less axial play than the main shaft 3 in its floating mountings. The predetermined value of the axial play of the speed indicator disk 26 is chosen such that it is smaller than a predetermined tolerance value of the speed sensor 22. The predetermined value of the axial play of the speed indicator disk 26 is also smaller than the axial play of the main shaft 3.

To reduce the wear of the guides 33, 35 and the rotation speed indicator disk 26, the side of the latter facing away from the speed sensor 22, i.e., its side formed by the covering disk 31 and thus engaged, faces toward the first groove flank 37. The side of the speed indicator disk 26 facing the speed sensor 22, in which the recesses 27 are provided, faces toward the second groove flank 39. The recesses 27 rotated through the all-round groove 34 are arranged to be opposite the engaged section 41.

Below, the operation of the transmission 1 will be explained briefly with reference to FIGS. 2 and 3. During the operation of the transmission 1, substantial axial displacements of the main shaft 3 in its floating mountings can take place. However, the rotation speed indicator disk 26 does not follow those movements completely, but rather, is held in the range between the two groove flanks 37, 39 since the speed indicator disk 26 can slide axially along the main shaft 3. Thanks to this reduction of the axial play of the rotation speed indicator disk 26 to a value below the permissible tolerance value of the rotation speed sensor 22, the speed at the speed indicator disk 26 can be determined reliably at any time regardless of the axial displacement of the main shaft 3. Furthermore, the main shaft 3, in its floating mountings, can undergo wobbling movements. In this case, too, the axial play of the rotation speed indicator disk 26, especially in its edge area, is reduced by the guides 33, 35 to a predetermined value such that the ability of the speed indicator disk 26 to tilt relative to the axis 5 of the main shaft 3 ensures that no loads are exerted on the rotation speed indicator disk 26 and the guides 33, 35.

### REFERENCE NUMERALS

| | |
|---|---|
| 1 | transmission |
| 2 | drive input shaft |
| 3 | main shaft |
| 4 | drive output shaft |
| 5 | axis |
| 6 | planetary gear system |
| 7 | countershaft |
| 8 | countershaft |
| 9 | axis |
| 10 | axis |
| 11 | transmission housing |
| 12 | drive gear wheel |
| 13 | drive gear wheel |
| 14 | drive gear wheel |
| 15 | fixed gear wheel |
| 16 | fixed gear wheel |
| 17 | fixed gear wheel |
| 18 | fixed gear wheel |
| 19 | loose gear wheel |
| 20 | loose gear wheel |
| 21 | rotation speed indicator |
| 22 | rotation speed sensor |
| 23 | holding arm |
| 24 | lead |
| 25 | evaluation unit |
| 26 | rotation speed indicator disk |
| 27 | recesses |
| 28 | edge of the rotation speed |
| | indicator disk |
| 29 | opening |
| 30 | perforated disk |
| 31 | covering disk |
| 32 | lateral recess |
| 33 | guide |
| 34 | all-round groove |
| 35 | guide |
| 36 | all-round groove |
| 37 | first groove flank |
| 38 | teeth |
| 39 | second groove flank |
| 40 | teeth |
| 41 | engaged section |
| 42 | bottom of groove |
| A | double arrow |
| B | double arrow |

1-16. (canceled)

17. A transmission with a rotational speed determining device comprising a rotation speed indicator (21) connected in a rotationally fixed manner to a transmission shaft (3) and a stationary rotational speed sensor (22) by way of which rotational speed of the transmission shaft (3) is determined from the rotation speed indicator (21), and the rotation speed indicator (21) extends radially outward into at least one guide (33, 35) which reduces axial play of the rotation speed indicator (21).

18. The transmission according to claim 17, wherein the guide (33, 35) co-operates with the rotation speed indicator such that the axial play of the rotation speed indicator (21) is reduced to a predetermined value.

19. The transmission according to claim 18, wherein the predetermined value is smaller than a predetermined tolerance value of the rotation speed sensor (22).

20. The transmission according to claim 18, wherein the predetermined value is smaller than axial play of the transmission shaft (3).

21. The transmission according to claim 17, wherein the rotation speed indicator (21) is arranged to move axially on the transmission shaft (3).

22. The transmission according to claim 17, wherein the rotation speed indicator (21) is arranged on the transmission shaft (3) to tilt relative to a longitudinal axis (5) of the transmission shaft (3).

23. The transmission according to claim 17, wherein the transmission (1) has at least one second transmission shaft (7, 8) and the guide (33, 35) is circumferential groove (34, 36) in or on the second transmission shaft (7, 8).

24. The transmission according to claim 23, wherein the second transmission shaft (7, 8) has a smaller axial play than the first transmission shaft (3).

25. The transmission according to claim 23, wherein the circumferential groove (34, 36) has two groove flanks (37, 39) which are formed by proximate sides of two adjacent gearwheels (15, 16; 17, 18) on the second transmission shaft (7; 8).

26. The transmission according to claim 25, wherein the rotation speed sensor (22) is orientated so that the rotation speed is determined in an axial direction from the rotation speed indicator (21).

27. The transmission according to claim 26, wherein the rotation speed indicator (21) is a rotation speed indicator disk (26) which has recesses (27) on a side facing toward the rotation speed sensor (22).

28. The transmission according to claim 27, wherein the recesses (27) are spaced away from an outer circumferential edge (28) of the rotation speed indicator disk (26).

29. The transmission according to claim 27, wherein the rotation speed indicator disk (26) is a perforated disk (30) and a covering disk (31) which are joined surface-to-surface with one another.

30. The transmission according to claim 27, wherein one of the at least two groove flanks (37) is formed exclusively by teeth (38) of a gearwheel (16, 18), and the side of the rotation speed indicator disk (26) facing away from the rotation speed sensor (22) faces toward one of the groove flanks (37).

31. The transmission according to claim 27, wherein one of the groove flanks (39) is formed at least partially by a closed section (41) of a gear wheel (15, 17), such that a side of the rotation speed indicator disk (26), facing toward the rotation speed sensor (22), faces toward the one of the groove flank (39) and the recesses (27) in the rotation speed indicator disk (26) are arranged opposite the closed section (41).

32. The transmission according to claim 23, wherein the first transmission shaft (3) is a main shaft and the second transmission shaft (7, 8) is a countershaft, and the main shaft is mounted floating between two countershafts.
